(19) United States
(12) Patent Application Publication
(10) Pub. No.: US 2008/0082190 A1
(43) Pub. Date: Apr. 3, 2008

(54) Software architecture for engineering analysis framework for semiconductor manufacturing

(76) Inventors: Sutirtha Bhattacharya, Hillsboro, OR (US); Hazem Hajj, Portland, OR (US)

Correspondence Address: TROP PRUNER & HU, PC, 1616 S. VOSS ROAD, SUITE 750, HOUSTON, TX, 77057-2631, US

(21) Appl. No.: 11/540,265

(22) Filed: Sep. 29, 2006

(51) Int. Cl. G06F 19/00

(52) U.S. Cl. 700/96; 700/121

(57) ABSTRACT

An engineering analysis system may provide an engineering analysis framework that operates both with an engineering analysis application and the databases that include the data to be analyzed. The framework includes a plurality of components which may be used in different combinations in different situations.

### BACKGROUND

This relates generally to semiconductor manufacturing operations and, particularly, to tools for the analysis of data from semiconductor processing operations.

One of the biggest challenges facing the semiconductor industry today is how to extract the nuggets of valuable information from huge volumes of data generated from complex manufacturing processes. Given the transition from 200 to 300 millimeter wafers and the inevitable evolution onto 450 millimeter wafers in the future, coupled with the proven sustainability of Moore's law, the volume of data generated is expected to grow. This data explosion makes extracting the useful information ever more challenging.

Future breakthroughs in manufacturing process optimizations, device enhancements, yield, or excursion analysis improvements hinge on the ability to extract the relevant data quickly and to derive the key learning from that data by performing relevant analyses. This learning potentially enables faster information turns, resulting in speedier processor technology improvements and proactive excursion detection, which, in turn, could result in million of dollars in savings. To support the identification timely delivery of these information nuggets, there is a need to focus on advanced software technologies for enabling just in time data extraction and analysis.

The current approach of building point solutions is inadequate to meet the requirements of semiconductor data analysis. Individual applications are built from the ground up with investment of significant resources. Often these point solutions miss key technology or process intercept targets, given the requirements and development complexity. Software is usually not reused on new projects. There is no standardization of the look and feel or the user experience among the myriad of tools that are developed and often similar functionality is delivered by multiple engineering applications, complicating the solution space.

### BRIEF DESCRIPTION OF THE DRAWINGS

FIG. 1 is a high level depiction of one embodiment of the present invention;

FIG. 2 is a more detailed depiction of the engineering analysis framework shown in FIG. 1 in accordance with one embodiment of the present invention; and

FIG. 3 is a more detailed depiction of the embodiment shown in FIG. 1 in accordance with one embodiment of the present invention.

### DETAILED DESCRIPTION

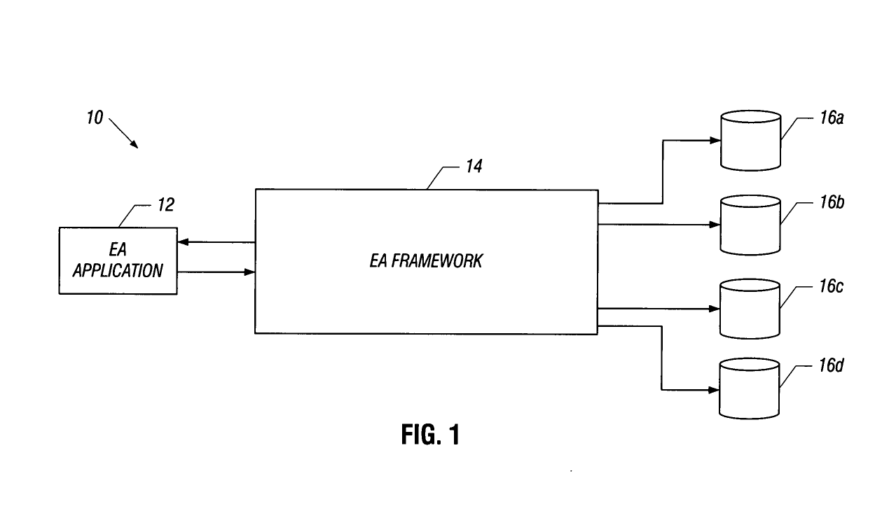

Referring to FIG. 1, a software architecture 10 may be utilized to facilitate engineering analysis of data from semiconductor manufacturing operations. That data may include information from a wide variety of different sources associated with semiconductor manufacturing. It may also involve data from a wide number of different applications used in a variety of different pieces of equipment associated with semiconductor processing. Particularly, when an excursion occurs, it is desirable to rapidly analyze the data which was developed over some period of time prior to the excursion. Because of the variety of different software packages and systems that are utilized, it may not be feasible to obtain a quick identification of the source of the excursion. The longer the downtime for the semiconductor manufacturing operation, the greater the losses and, in a high volume manufacturing operation, these losses may be enormous.

An engineering analysis application 12 may be utilized to analyze data from a variety of different domains indicated as 16a, 16b, 16c, and 16d. An engineering analysis application is a software product that enables analysis capabilities such as trending, commonality, or correlation on engineering data from a semiconductor manufacturing process. The number of data domains may expand over time, but may include at least the following data domain models. Statistical process control data primarily consists of metrology data in a matrix plotted on control charts and used to monitor the process. Run to run control data consists of metrology data, after sources other than the statistical process control data, and recommended or actual setting data. Fault detection and classification data consists primarily of trace data during running of process equipment and information on faults, such as detection alarms, classification information, and the like. Work-in-process history contains information on the flow of material through various processing and metro operations, entities, and sub-entities. Entity attributes are typically information on the state of a tool at a given time. The attributes may be developed by counters which indicate the number of wafers since the last preventive maintenance. Preventive maintenance data contains details on the maintenance activities such as the type and identifier of the part changed. The yield data gives inline and end-of-line yields and defect information. Bin test results has binning information that describes whether a die works and, if not, the type of failure. In addition, there may be various parametric test data. Electrical test data has results from various electrical tests, such as current voltage, capacitance voltage, and the like. Facilities data includes various environmental data, such as temperature, pressure, and the like. Assembly test data includes information on testing done after the die is packaged. Joining the raw data to the engineering application 12 may be an engineering analysis framework 14.

In one embodiment, the engineering analysis framework 14 includes a large number of components which are combinable in ways that enable selection of only those components that may be desired for any given situation. In addition, the modular nature of the components making up the engineering analysis framework ensures that those components may be used with different products in future technologies. Thus, by providing these components in a modular fashion, they may be available for use either alone or in combination with the other components as the need may arise. Generally, this means that interfaces between components must be clean and general, rather than specific, so that they may interface with any other components in combinations selected by those doing the engineering analysis. Dependencies between components must either be nonexistent or well understood so that those dependencies can be made known to those using the components individually or in novel combinations.

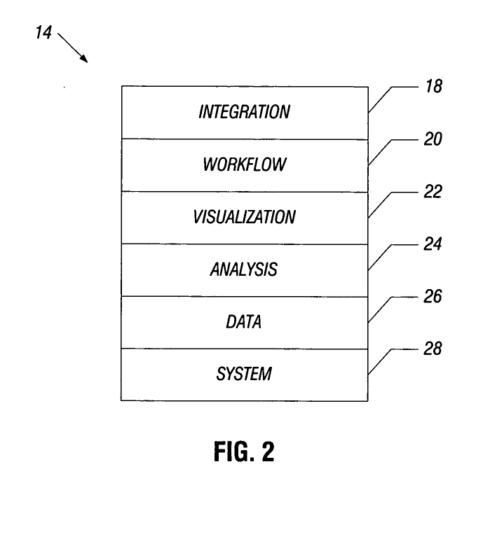

The engineering analysis framework 14 may, as shown in FIG. 2, be broken down into layers of components with common functions. These may include core capabilities derived from commercial off-the-shelf components or custom capabilities built at a specific semiconductor processor. The system services layer 28 may include components to provide services such as security, logging, and load balancing, to mention a few examples, that may be required by other engineering analysis framework service layers, as well as engineering analysis applications.

Next comes the data services layer 26 which includes components that provide services that support data extraction and data preparation for analysis. The analysis services 24 may include components to provide statistical analysis capability and canned algorithms relevant for data analysis in the semiconductor processing domain. The visualization services 22 include components for user interface controls used to support user interactions with the engineering analysis applications. The workflow services layer 20 includes components to provide services that enable the execution of on-demand or time/event based scheduled jobs using a pipe and filter architecture style. Thus, processing by a series of analysis components or applications may be implemented. Finally, the integration services layer 18 includes components for integration of different engineering analysis framework subsystems and components with each other, as well as with other systems in an automation infrastructure.

Each of the layers 18-28 may include a large number of components. Each of these components may be reusable, in the same way that the layer itself is reusable, and interdependent, in the same way each of the layers are independent. Namely, each of the components may be selectively usable in various combinations that are too numerous to enumerate. Thus, a given engineer may decide to select components and configure a framework in a specific fashion. These components work together because that is the way they are configured. Thus, each of the components within a given layer may be dynamic link libraries, in one embodiment, installed separately from the engineering analysis application. The engineering analysis application may use those functionalities encapsulated within the dynamic link libraries for delivering the end user functionality. In one embodiment, the framework may be developed in the .net platform using C# programming language.

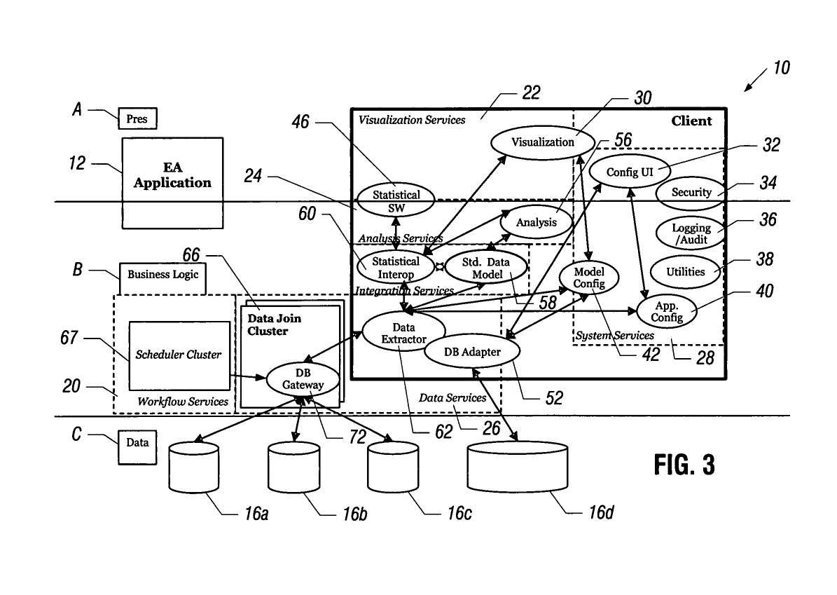

Moving on to FIG. 3, a more detailed embodiment is illustrated. The arrangement is divided into an upper presentation layer A, an intermediate business logic layer B, and a data layer C. The presentation layer may include configuration user interfaces 32 for managing configurations in an engineering analysis framework database 16d which is a repository for configuration information. This may include creating, modifying, or deleting those configurations. It may also include a visualization subsystem 30 for common user interface widgets and controls.

The business logic layer B may include an analysis subsystem 56 for basic statistics, filtering algorithms, and indicator calculations. It may also include an application configuration subsystem 40 that enables persisting and retrieval of user and application specific configurations. A data extractor subsystem 62 extracts and joins data for multiple data sources. The database adapter 52 handles translation of relational data formats into generic schema of the engineering analysis framework database 16d. The database gateway 72 of a data join cluster 66 includes data join solutions for query optimization over multiple databases. Logging and audit subsystems 36 enable logging and audit functionality. The model configuration subsystem 42 manages metadata for the engineering analysis framework and handles domain configurations for engineering analysis applications. This domain configuration may include query models and parameter models that are the configurations to dynamically generate a database query based on user selections from a user interface. The query model is the query specific configuration, while the parameter model refers to the parameters associated with the query. The security subsystem 34 enables authentication and authorization for the engineering analysis framework based applications. The standard data model subsystem 58 enables a consistent memory data format. The statistical software 46 is a commercial, off-the-shelf data mining component. Statistical Interop 60 is .net interop wrapper for a statistical software. Utility subsystems 38 provide utilities for encryption, registry access, and other capabilities for both engineering analysis framework and engineering analysis application components. The scheduler cluster 67 supports execution of batch jobs scheduled by the client.

The data layer C includes the various data domains already described herein. A framework approach to building of engineering analysis applications for semiconductor manufacturing may identify key functional services for engineering analysis software, comprehending weight requirements across pre-wafer, fabrication, sort, and electrical test domains. The framework may be built from the ground up and need not be put together with pre-built components, but, instead, may be designed and developed as framework components.

The engineering analysis framework has several subsystems, as shown in FIG. 3. Each of these subsystems has several components. There are some implicit dependencies on subsystem interactions. For example, the data extractor subsystem 62 from the data services layer 26 has an implicit dependency on the query model configuration subsystem 42 in the system services layer 28. So an engineering analysis application 12 that uses a data extractor subsystem 62 may use the query model configuration subsystem 42 implicitly. On the other hand, the data analysis layer 24 is independent of the other subsystems and can be used in complete isolation. With respect to the visualization services layer 22, while one visualization control, such as the material selection user interface component, can be used independently of the operation selection or material prefetched user interface, all of these user interface controls may use the data extractor subsystem 62 in the background.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
providing a framework for engineering analysis of semiconductor manufacturing operations that operates with an engineering analysis application and a plurality of semiconductor processing databases and includes a plurality of components operable in user selectable combinations.

2. The method of claim 1 including operating said framework with at least two distinct databases.

3. The method of claim 2 enabling data to be extracted from said databases in response to one query for both databases.

4. The method of claim 1 including providing a plurality of layers within said framework, including a data services layer including components that provide services that support data extraction and data preparation for analysis.

5. The method of claim 4 including providing a layer including components to provide statistical analysis.

6. The method of claim 5 including providing a layer with components for user interface controls.

7. The method of claim 6 including providing a layer to enable execution of on demand or time/event based scheduled jobs.

8. The method of claim 7 including providing a layer for integration of components with one another.

9. The method of claim 1 including providing an engineering analysis framework that operates with databases including at least two of the following: electrical tests, sort tests, process control, and work in process history.

10. A computer readable medium storing instructions that enable a processor-based system to:
provide a framework for engineering analysis of semiconductor manufacturing operations that operates with an engineering analysis application and a plurality of semiconductor processing databases and includes a plurality of components operable in user selectable combinations.

11. The medium of claim 10 further storing instructions to operate said framework with at least two distinct databases.

12. The medium of claim 11 further storing instructions to enable data to be extracted from said databases in response to one query for both databases.

13. The medium of claim 11 further storing instructions to provide a plurality of layers within said framework, including a data services layer including components that provide services that support data extraction and data preparation for analysis.

14. The medium of claim 13 further storing instructions to provide a layer including components to provide statistical analysis.

15. The medium of claim 14 further storing instructions to provide a layer with components for user interface controls.

16. The medium of claim 15 further storing instructions to provide a layer to enable extraction of on demand or time/event based scheduled jobs.

17. The medium of claim 16 further storing instructions to provide a layer for integration of components with one another.

18. The medium of claim 10 further storing instructions to provide an engineering analysis framework that operates with databases including at least two of the following: electrical tests, sort tests, process control, and work in process history.

19. A system comprising:
an engineering analysis application;
an engineering analysis framework; and
a plurality of databases coupled to said engineering analysis framework, said framework including a plurality of components operable in user selectable combinations.

20. The system of claim 19 wherein said framework can extract data from said databases using a single query that extracts information across at least two databases.

21. The system of claim 20 wherein said framework includes a plurality of layers including a data services layer including components that provide services that support data extraction and data preparation for analysis.

22. The system of claim 21 including a layer for integration of components with one another.

23. The system of claim 21 including a layer including components to provide statistical analysis.

24. The system of claim 23 including a layer with components for user interface controls.

25. The system of claim 21 including a layer to enable execution of on demand or time/event based scheduled jobs.
